(19) United States
(12) Patent Application Publication
(10) Pub. No.: US 2024/0149350 A1
(43) Pub. Date: May 9, 2024

(54) SYSTEMS, DEVICES, AND METHODS FOR IN SITU LASER SHOCK PEENING DURING ADDITIVE MANUFACTURING

(71) Applicant: Massachusetts Institute of Technology, Cambridge, MA (US)

(72) Inventors: Cemal Cem TASAN, Cambridge, MA (US); Jiyun KANG, Boston, MA (US)

(21) Appl. No.: 18/548,639

(22) PCT Filed: Apr. 15, 2022
(86) PCT No.: PCT/US2022/025138

§ 371 Date: Sep. 1, 2023

Related U.S. Application Data
(60) Provisional application No. 63/175,543, filed on Apr. 15, 2021.

(51) Int. Cl. B22F 10/64; B33Y 10/00; B33Y 30/00; B33Y 40/20; C21D 10/00

(52) U.S. Cl. CPC B22F 10/64; B33Y 10/00; B33Y 30/00; B33Y 40/20; C21D 10/005

(57) ABSTRACT

Systems, devices, and methods for improved manufacturing of parts are disclosed. One or more devices realize in situ laser shock peening for selective laser melting process to allow for microstructural control of a manufactured part, both locally and globally. The device can include a platform, an energy source (e.g., a laser), an applier to provide one or more opaque materials to form an opaque overlay, and one or more transparent materials that is/are disposed above the deposited opaque material to form a transparent overlay. The platform can include at least a first conduit used with generating a shock wave as part of the peening process and a second conduit to receive a vacuum device for residue collection from the peening process. The platform can be configured to translate relative to the sample on which the peening process is performed such that printing, peening and vacuuming can be performed substantially simultaneously.

### CROSS REFERENCE TO RELATED APPLICATION

The present disclosure claims priority to and the benefit of U.S. Provisional Application No. 63/175,543, entitled “Systems, Devices, and Method for in Situ Laser Shock Peening During Additive Manufacturing,” filed on Apr. 15, 2021, the content of which is incorporated by reference herein in its entirety.

### FIELD

The present disclosure relates to systems, devices, and methods for improved manufacturing of objects (e.g., metal- and ceramic-based), and more particularly relates to a device and/or system that can be added to an additive manufacturing process to enable in situ modification of structures and properties of products.

### BACKGROUND

Conventional techniques for manufacturing metallic components and parts involve casting, cold/hot working, annealing, and forming to achieve desired compositions, shapes, and properties. In recent years, alternative ways of manufacturing objects have begun to gain traction in the marketplace. Additive manufacturing (“AM”), also generally referred to as three-dimensional (“3D”) printing, is growing in popularity as a way to prototype and manufacture physical objects. AM enables flexibility in design and material, as well as reduces lead time and waste. There are multiple known techniques for printing metal-based materials, such as powder bed fusion, material/binder jetting, lamination, and direct energy deposition (“DED”). Selective laser melting (“SLM”), for example, is one of the powder bed fusion techniques, which utilizes a high-power density laser to melt and fuse fine metallic powders to build a component. Specifically, in SLM, a thin layer of powder is evenly distributed on a substrate by a recoater, a roller, or a slider, and a laser is used to melt and fuse the powders together. After melting of one layer, a second powder layer is distributed by the recoater and the process is repeated to make a 3D part. Exemplary embodiments of an SLM printer and an SLM process are provided in FIGS. 1 and 2 of the present application. The laser can etch or melt a desired design in first powder layers, with subsequent layers being added onto the previous layers to fuse the layers together to manufacture the part.

An SLM process can be potentially combined with one or more processing/treatment techniques to more efficiently manufacture parts, and better control microstructures and properties. For example, SLM can be combined with technologies such as laser shock peening (“LSP”), which enables printing the shape of a component and tailoring its microstructure at the same time. In LSP, a pulsed laser is utilized to introduce plastic deformation and favorable residual stresses. In this process, the shock wave is generated upon the irradiation of the laser and the wave introduces cold work and residual stresses into the metallic component as it propagates into the material. This, in turn, leads to an increase in surface hardness and fatigue life of the part. To improve the efficiency of the process, it is common to apply a plurality of layers above a metallic substrate, for example, a transparent overlay placed on an opaque overlay. The transparent overlay can be water or glass while the opaque overlay can include black paint or tape. The opaque overlay can absorb the laser beam when contacted, causing a rapid generation of a shock wave on the surface of the opaque overlay. In some material systems, application of opaque layers can be omitted. By combining SLM and LSP, multiple lasers can operate in this system to melt powder layers to print the part and introduce desired deformation to specific locations of the printed part.

The above-described manufacturing techniques, including attempts to incorporate LSP techniques into SLM manufacturing processes, suffer from a number of shortcomings. For example, the opaque overlay can be applied non-uniformly and can be supplied in varying quantities, thereby resulting in a non-uniform thickness of the opaque overlay on each part. Moreover, the non-uniform application of the opaque overlay can result in imperfect contact between the opaque overlay and the substrate on which the opaque overlay is applied, resulting in manufacturing of parts that are overly deformed in some area and have less than the desired deformation in others. Still further, after application of the opaque overlay, there may be difficulties in removing the residue or byproducts after LSP is performed, which results in intensive manual effort, powder loss, and heavy wear and tear on the machinery, necessitating high maintenance and replacement costs.

Accordingly, there is a need for improving the systems and processes for efficient manufacturing and control of printed parts.

### SUMMARY

The present application is directed to systems, devices, and methods for improved manufacturing of parts. Specifically, one or more devices, referred to as a peening device or an LSP device herein, can realize an in situ LSP for SLM process, which enables more efficient and sophisticated control of microstructures of the manufactured part and efficiently removes any residues of the multi-laser operations to increase efficiency in the process and decrease maintenance costs. The one or more devices, which in combination may be referred to as a system, can include a peening device having one or more conduits for delivering an opaque overlay, e.g., ink and a vacuum device such as a vacuum pump. The conduits can allow for lasers to interact with the opaque overlay to increase a surface hardness and fatigue life of the part, while the vacuum pump can clean up residues. The laser and the vacuum pump can work substantially simultaneously such that the laser cold works the part, while the vacuum pump sucks up residues to ensure a uniform surface of the resulting part, thereby reducing the time taken for manufacture.

The systems and methods disclosed herein have a wide variety of potential applications. These include, by way of non-limiting examples, use in manufacture of various structural components used in automobiles, support of offshore plants and vessel steels, and engines or bodies of airplanes and spacecraft. The parts that can be manufactured by the presently disclosed systems, devices, and methods can include all kinds of metals, metal-metal composites, metal-matrix composites, ceramics, ceramic-ceramic composites, and/or metal-ceramic composites.

The processes provided for utilize steps of selectively melting one or more layers in a printing process to manufacture a part. Once a sufficient number of layers are built by SLM, an LSP device is moved to the build plate on which the part resides, and a liquid-type (e.g., solutions, dispersions, colloids, suspensions) or powder-type opaque overlay can be injected onto the part. A transparent overlay is then inserted into the system, and a pulsed laser can be activated to travel through the transparent overlay into the opaque overlay. The shock waves are generated on the surface of the opaque overlay, propagate through the part, and deform the part. After one or more LSP operations are performed in the first location, the LSP device can be moved to a new position along the sample or substrate and a vacuum can be applied to remove residue of the opaque overlay and by-products of the ablation of the opaque overlay.

One exemplary embodiment of a printer includes a vessel, a platform, a first energy source, an applier, one or more transparent materials, and a laser. The vessel is configured to supply one or more layers of a substance onto a build plate. The substance includes at least one of one or more powders or one or more wires. The platform has one or more conduits formed in it. The first energy source is configured to at least one of melt or fuse the one or more layers of substance to form a printed part. The applier is configured to deposit one or more opaque materials on the one or more solidified layers of the printed part to form an opaque overlay, with the one or more opaque materials comprising energy-absorbing particles suspended in a liquid. The transparent material(s) is configured to be disposed above the deposited opaque materials to form a transparent overlay. The laser is in communication with at least one conduit of the one or more conduits. Further, the laser is configured to irradiate at least a portion of at least one of the one or more deposited opaque materials that form the opaque overlay or the one or more transparent materials that form the transparent overlay. Additionally, at least one conduit of the one or more conduits is configured to be in communication with a cleaning system that is configured to remove at least a portion of residue from at least one of the one or more opaque materials or the one or more transparent materials. The removed portion is not necessarily the irradiated portion.

The first energy source can include at least one of a laser or an electron beam. A diameter of the platform can be approximately in the range of about 15 millimeters to about 150 millimeters. The platform can be configured to translate relative to the one or more melted layers of the printed part such that the second energy source can be configured to irradiate at least a portion of the one or more deposited opaque materials that form the opaque overlay and/or the one or more transparent materials that form the transparent overlay at a plurality of positions.

The printer can further include a cleaning system. The cleaning system can be in communication with at least one conduit of the one or more conduits, and further, the cleaning system can be configured to collect the residue of the irradiation. The residue of the irradiation can further include one or more of: i) a remnant of the one or more deposited opaque materials that form the opaque overlay after irradiation; ii) a byproduct produced by reactions between the laser and the deposited opaque materials or the deposited transparent materials; iii) a byproduct produced by reactions between the laser and the printed part; iv) a remnant of the one or more deposited transparent materials that form the transparent overlay after irradiation; and/or v) a contaminant of the irradiation. In some embodiments, the cleaning system can include a vacuum system and/or a system configured to wipe, sweep, and/or use adhesive tapes to remove the residue.

One exemplary method for manufacturing a part includes positioning a sample onto a build plate of a printer, and positioning a platform having one or more conduits in a first position over the sample. The method further includes activating a laser to irradiate the sample, translating the platform to a second position relative to the sample, and removing a residue that results from laser irradiation. The method still further includes activating the laser to irradiate a further portion of the sample.

In some embodiments, the method can further include depositing a first material onto the sample to form an opaque overlay, contacting the first material with a second material being made of a substantially transparent material to form a transparent overlay, and irradiating the first material and/or the second material with the laser. In some embodiments, depositing a first material onto the sample to form an opaque overlay can include flowing or injecting the first material through a supplier to an opening of the one or more conduits. The first material can include one or more of: a liquid mixture that includes oil or water; one or more inks; one or more solutions; one or more dispersions; one or more colloids; one or more suspensions; and/or one or more powder materials.

The residue can include one or more of: i) a remnant of the irradiated first material; ii) a byproduct produced by reactions between the laser and the first material or the second material; iii) a byproduct produced by reactions between the laser and the sample; iv) a remnant of the irradiated second material; and/or v) a contaminant of the irradiation. Removing the residue can include applying a vacuum, wiping, sweeping, and/or using adhesive tapes to remove the residue. In some embodiments, the vacuum can be in communication with the one or more conduits of the platform to remove the residue. Activating the laser and removing the residue can occur substantially simultaneously. In some embodiments, removing a residue that results from laser irradiation can include removing a residue of at least one of the transparent overlay or the opaque overlay after irradiating one or more of the first material or the second material with the laser. In at least some embodiments, the method can include repeating the following actions one or more additional times: activating the laser to irradiate the sample; translating the platform to at least one additional position relative to the sample; and removing a residue that results from laser irradiation.

One exemplary manufacturing system includes a peening device and a cleaning device. The peening device has one or more conduits formed in it, with the conduits extending substantially from a proximal end of the peening device to a distal end of the peening device to form an access path through the peening device. The cleaning device is in communication with one or more conduits of the one or more conduits of the peening device. The cleaning device is configured to clean residue that results from use of the peening device.

The system can include a supplier configured to deliver an opaque material to form an opaque layer on a surface of the peening device. The opaque material can be one or more of a liquid mixture of oil/water, inks, solutions, dispersions, colloids, suspensions, and/or a powder material. In some embodiments, a transparent material can be configured to be disposed above the opaque material delivered by the supplier. The transparent material can be configured to be disposed substantially uniformly over the opaque material. The transparent material can be configured to receive a laser through it, with the laser traveling substantially unimpeded through the transparent material to be absorbed by the opaque material.

In some embodiments, the laser and the cleaning device can be configured to operate substantially simultaneously. The supplier can be configured to deliver the opaque material substantially uniformly over one or more of the printed part or the surface of the peening device. The peening device can be configured to translate relative to the supplier.

A diameter of the platform can be approximately in the range of about 15 millimeters to about 150 millimeters. In some embodiments, the cleaning device can extend at least one of distal to the distal end of the peening device or distal to a side end of the peening device.

### BRIEF DESCRIPTION OF THE DRAWINGS

This disclosure will be more fully understood from the following detailed description, taken in conjunction with the accompanying drawings, in which:

FIG. 1 is a schematic illustration of one embodiment of a prior art SLM printer;

FIG. 2 is a schematic illustration of a prior art SLM process for manufacturing a finished part;

FIG. 3A is a schematic top view of one exemplary embodiment of a device added to an additive manufacturing SLM process to realize in situ LSP operations;

FIG. 3B is a schematic bottom view of the exemplary embodiment of FIG. 3A;

FIG. 4A is a schematic cross-sectional view of the device of FIG. 3A taken along line A-A, illustrating a first position of the device in which an opaque layer is supplied to the device;

FIG. 4B is the schematic cross-sectional view of FIG. 4A in the first position in which a transparent overlay contacts the opaque layer and a laser is activated;

FIG. 4C is the schematic cross-sectional view of FIG. 4A illustrating the device moving to a second position while removing the residue of the liquid opaque layer and any byproduct of the laser peening process at the first position via a vacuum pump, which can be another cleaning system in other embodiments;

FIG. 4D is a schematic representation of the sample showing a size of a pulsed laser beam irradiation on a surface area thereof;

FIG. 5 is a schematic side perspective, partially transparent view of another exemplary embodiment of a device added to an additive manufacturing SLM process to realize in situ LSP operations;

FIG. 6 is a schematic representation of an exemplary embodiment of an operation procedure using the devices of the present embodiments;

FIG. 7 is a schematic representation of layers of an object following an additive manufacturing SLM process having LSP performed on each layer;

FIG. 8A is a table illustrating time taken to manufacture a printed object using conventional manufacturing techniques and post-processing heat treatments;

FIG. 8B is a table illustrating time taken to manufacture a printed object using the operation procedure shown in FIG. 6;

FIG. 9A is a top perspective view of a stage configured to be used with the device of FIG. 5;

FIG. 9B is a top perspective view of a base plate coupled to the stage of FIG. 9A;

FIG. 9C is a top perspective view of a series of samples loaded onto the base plate of FIG. 9B;

FIG. 9D is a top perspective view of an opaque layer deposited onto the series of samples of FIG. 9C;

FIG. 9E is a top perspective view of a transparent layer deposited over the opaque layer of FIG. 9D;

FIG. 9F is a top perspective view of the stage of FIG. 9E having a sample cover installed onto the series of samples and the transparent layer of FIG. 9E;

FIG. 10A is an image of a surface of a sample after being exposed to laser irradiation; and

FIG. 10B is a magnified image of a portion of the surface of the sample of FIG. 10A showing twins and dislocations formed therein.

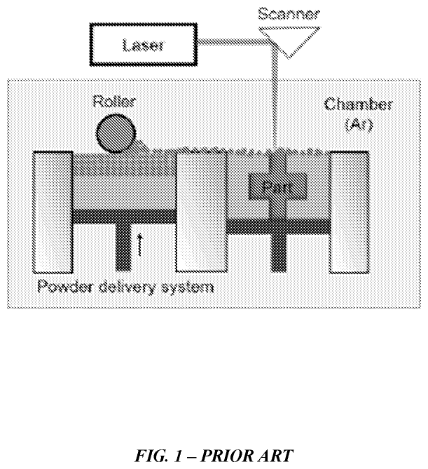

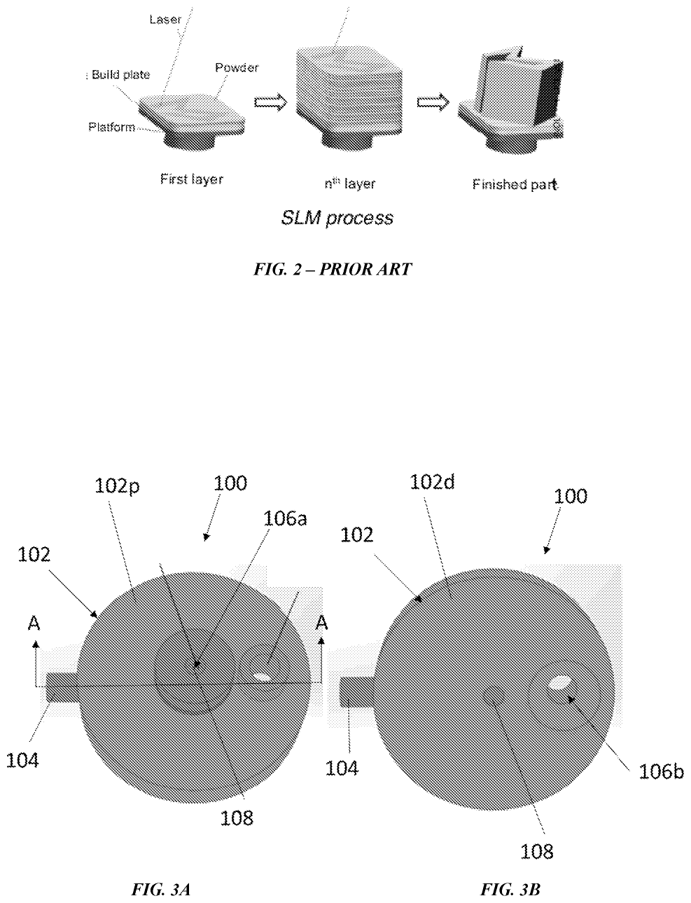

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, compositions, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Like-numbered components across embodiments generally have similar features unless otherwise stated or a person skilled in the art would appreciate differences based on the present disclosure and/or his/her knowledge. Accordingly, aspects and features of every embodiment may not be described with respect to each embodiment, but those aspects and features are applicable to the various embodiments unless statements or understandings are to the contrary.

To the extent that the instant disclosure includes various terms for components and/or processes of the disclosed systems, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, a person skilled in the art will recognize various terms that are used herein interchangeably, such as the terms “opaque layer” and “opaque overlay” to refer to any kind of materials including energy absorbing dispersants such as ink or powder used in LSP, the terms “transparent layer” and “transparent overlay” to refer to transparent substances such as water, glass, or plastics that allow the laser to pass therethrough, and the terms “sample” and “substrate” to refer to the manufactured part onto which the opaque layer and/or the transparent overlay is applied. Further, a person skilled in the art will recognize that while the term “overlay” can be used to refer to a layer of material after it has been deposited, or alternatively and/or additionally, the term “overlay” can refer to the material prior to it being deposited.

At least one novel aspect of the present disclosure lies in a device that improves an in situ LSP treatment for SLM processes. The device can allow for microstructural control of a manufactured part, both locally and globally. In some embodiments, the device can include a supplier, in some instances referred to as an applier, and a conduit for a vacuum attachment for use with in situ LSP during SLM. A person skilled in the art will recognize that the device can allow for one or more suppliers and/or appliers to deliver the opaque layer to a surface of the peening device, which in some instances may be referred to as a platform. The supplier and/or applier can include any instrument, device, or the like capable of applying the opaque layer. For example, in some embodiments, the supplier and/or applier can control an amount and/or flow of the opaque layer being introduced into the system to ensure uniformity and/or control of a desired thickness of the opaque layer throughout the surface of the substrate. While the presently disclosed embodiments are discussed with respect to in situ LSP during SLM, it will be appreciated that SLM is one example of a type of metal 3D printing techniques, and the LSP techniques discussed herein can be used with other forms of additive manufacturing, such as resin, powder bed fusion, material/binder jetting, extrusion, lamination, and/or direct energy deposition.

The opaque layer can include a thickness of approximately 100 microns, though, in some embodiments, the thickness can range from several microns to several millimeters (e.g., approximately in the range of about 5 microns to about 10 millimeters). The opaque layer can be made up of, for example, one or more materials configured to absorb a laser beam, such as a liquid mixture of oil or water and energy-absorbing dispersants, such as inks, solutions, dispersions, colloids, or suspensions, or a powder material. In some embodiments, the opaque layer can include a liquid suspension of energy-absorbing particles. The energy-absorbing particles can be configured to absorb the energy from the incident laser to generate a shock wave that creates an increase in surface hardness and fatigue life of the manufactured part. It will be appreciated that the platform 102 can be used in a printer that utilizes one or more energy sources, e.g., a continuous laser, a pulsed laser, and/or an electron beam. Among the sources, a pulsed laser can be used for LSP and can irradiate the opaque layer. Some additional non-limiting examples of the opaque layer, and/or components of the opaque layer, can include a powder layer or a liquid layer. For example, in some embodiments, a liquid opaque layer can include a mixture of base material such as water or oil, and energy-absorbing dispersants, e.g., energy-absorbing particles, like graphite, carbon black, black ferric oxides, and/or mixtures of thereof. The concentration or consistency of the energy-absorbing particles may affect efficiency with which the generated shock wave alters the surface hardness and fatigue life of the manufactured part.

It will be appreciated that the opaque layer can be used with most metals to protect the surfaces of substrates and increase absorption of a laser beam, as the high reflectivity properties of most metals would cause the energy to be reflected rather than absorbed. In some embodiments, such as for metals having less reflective surface conditions and/or for a laser beam having a wavelength where the absorption is strong, the opaque layer can be omitted, as metals would sufficiently be deformed by energy from the source in such conditions.

Conventional metal 3D printing methods in general include a separate step of homogenizing the 3D printed components after the printing process. For example, once the structure is printed, an extra step of homogenizing microstructures is performed, which can be very costly, time intensive, and create shape distortion beyond acceptable tolerance limits. Specifically, current production of parts includes taking a solid structure to a furnace for a stress relief process to be performed thereon, or for anisotropic solid microstructure to be removed therefrom, with the surface machined to improve service quality. The instantly disclosed embodiments reduce or remove the need for post processing treatment of the structure by incorporating LSP during printing.

Adding LSP to SLM can introduce deformation, which allows use of thermal and mechanical energy to control microstructural matters. FIGS. 3A-3B illustrate an exemplary embodiment of an LSP device 100 that is used to realize the in situ LSP operations during an SLM process. As shown, the device 100 can include a surface or platform 102 that extends between a proximal end 102p and a distal end 102d. The platform 102 can include a supplier 104 attached thereto. The supplier 104 can include a tube or another delivering means that extends through the platform 102 to allow introduction of one or more substances into the platform.

The platform 102 can include one or more conduits 106 formed therein. The conduits 106 can be in communication with the supplier 104 to allow one or more devices inserted through the conduits 106 to interact with the supplier and the substance delivered therein. For example, as shown, a first conduit 106a can include an access path that extends from the proximal end 102p through the platform 102 and terminates at the distal end 102d.

In some embodiments, a transparent layer 108 can be coupled to the platform 102 or otherwise disposed in the first conduit 106a to be overlaid onto the opaque layer 110 delivered by the supplier 104. The transparent layer 108 can include any liquid or solid material that can serve as a substantially transparent or penetrable barrier through which a laser beam or energy source can travel while not exhibiting dielectric breakdown, or exhibiting reduced dielectric breakdown, during the irradiation process. A transmittance of the transparent layer 108 of the present embodiments can depend, at least in part, on the type of material, a thickness of the material, and/or wavelength of the laser used for irradiation, among others. For example, for infrared lasers, e.g., lasers with a wavelength of approximately 1064 nm, the transmittance (%) of the laser beam through sapphire can be about 85%, while the transmittance through fused silica can be about 94%. Use of materials with such transmittance can be advantageous at least because materials that are substantially transparent can allow a laser beam to travel through them without losing substantial amounts of energy. A person skilled in the art will recognize that a transmittance of the transparent layer 108 considered to be substantially transparent according to the present embodiments is a material that allows a laser beam or energy source to travel therethrough while maintaining approximately in the range of about 60% to about 100% of its energy and/or temperature, or alternatively, approximately in the range of about about 70% to about 100% of its energy and/or temperature, or, further alternatively, approximately in the range of about 80% to about 100% of its energy and/or temperature. Some additional non-limiting examples of the transparent layer can include glass, water, fused silica, quartz, glass, non-corrosive liquids and/or mixtures of thereof.

The platform 102 can include a second conduit 106b that serves as a vacuum pump connection. As shown, the second conduit 106b can extend through the platform 102 to form an access path for a pump to extend therethrough. A person skilled in the art will recognize that the second conduit 106b, while shown extending from the proximal end 102p to the distal end 102d, e.g., be positioned at a substantially perpendicular angle relative to the platform, can, in some embodiments, extend through/from a side surface of the platform 102 towards the distal end 102d.

The platform 102 of the present disclosure provides compactness to three-dimensional printing. For example, the platform 102 of the embodiments of FIGS. 3A-3B, can include a diameter of approximately 25 millimeters, though, in some embodiments, the diameter can be approximately in the range of about 5 millimeters to about 750 millimeters, approximately in the range of 10 millimeters to about 250 millimeters, or approximately in the range of about 15 millimeters to about 150 millimeters, while being ergonomically designed to be simple and lightweight. A person skilled in the art will recognize that while a cylindrical shape is shown, in some embodiments, the platform 102 can be shaped as a rectangular prism, a cube, a pyramid, a sphere, and so forth, having one or more conduits formed therein or attached thereto. Further, its compactness ensures better compatibility and attachment to current 3D printers, including 3D printers used to print metal parts, as compared to a bulky roller or slider type for controlling opaque and transparent overlays. The dimensions of the presently disclosed platform 102 allow for substantially uniform contact between the sample and the layers and/or between overlays, e.g., the opaque overlay and the transparent overlay. The uniform contact allows the shock waves to propagate through a clean path with few barriers as well as efficient, consistent, and stable operation of the LSP process. Moreover, the uniform thickness of the opaque layer, which, in some embodiments, can be approximately in the range of about 50 μm to about 200 μm, can be achieved. It will be appreciated that the microstructural control afforded by the systems and devices of the present disclosure can allow for adjustments of the thickness of the opaque layer by increments of approximately one micron.

In use, a sample can be built onto a build plate of a 3D printer. The sample, which can include one or more layers of powder and/or wires as a feedstock, can be placed in a known location from a vessel, e.g., a container, a feeder, or another object, e.g., a recoater, a roller, or a slider that can be used in techniques such as SLM, that is configured to hold and/or deliver a substance for use in additively manufacturing printed parts. The sample can be irradiated with a laser that selectively melts one or more powder layers to build the sample at predetermined locations. A person skilled in the art will appreciate that the laser can be applied to the sample as a whole and/or to specific locations along a surface thereof to allow for granular control of selected areas of the sample where melting is desired.

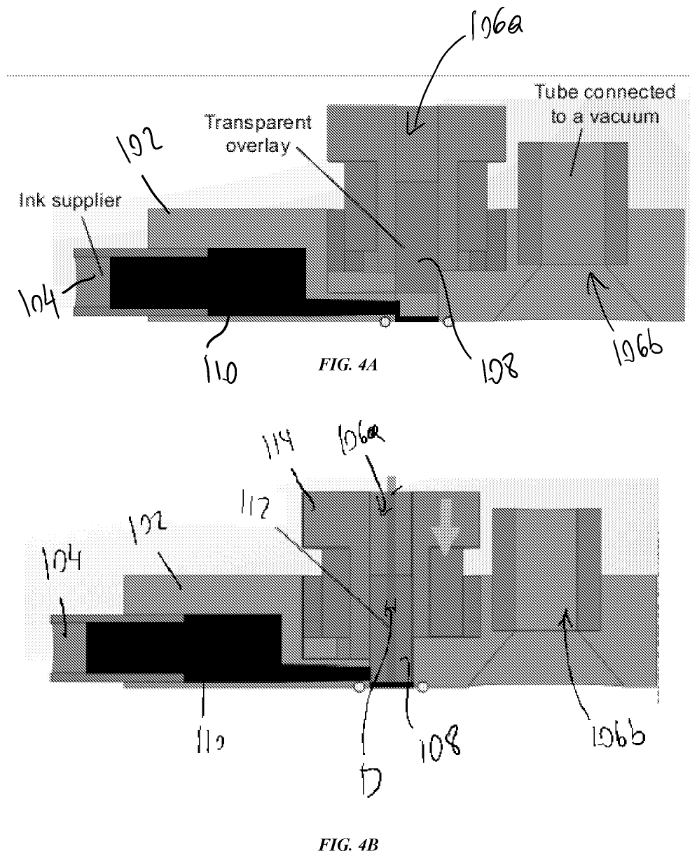

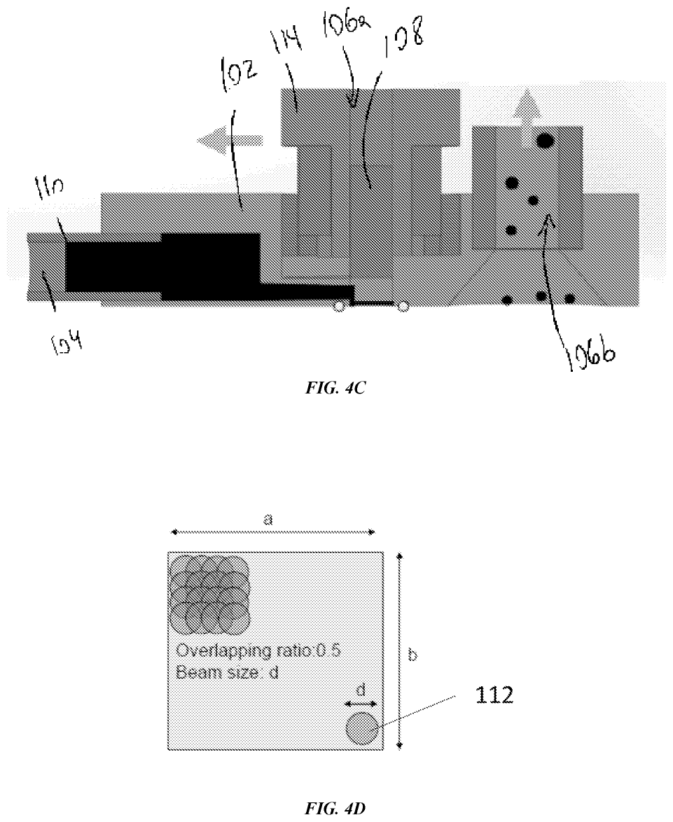

Once a sufficient number of layers are melted by SLM, the LSP device can be moved to the build plate and positioned at a first position relative to the build plate. For example, as shown in FIG. 4A, showing the platform in cross-section taken along the line A-A, the liquid or powder layer 110 can be introduced onto the substrate on the build plate. The liquid or powder layer 110 can serve as the opaque overlay from which the substrate is processed. The opaque overlay 110 can be introduced through the supplier 104 to the substrate via flowing or injection such that the substance is in communication with at least the opening of the first conduit 106a.

The transparent overlay 108 can act as a second layer that contacts the opaque overlay 110 and a pulsed laser is irradiated on the opaque and/or transparent layers. As discussed above, a translatable portion 114 of the platform 102 can move distally towards the opaque overlay 110 to position the transparent overlay 108 over the opaque overlay 110. The opaque overlay 110 absorbs the energy of the laser, which can cause ablation of the opaque layer. While a single opaque overlay is shown, a person skilled in the art will recognize that two or more opaque overlays can be used within the process (or no opaque layer, as referenced above). A diameter D of the laser 112, a beam size of the laser, can be approximately a millimeter, though, in some embodiments, other sizes are possible and the size can be varied during use.

In some embodiments, the locations along the sample that the laser 112 irradiates can overlap to ensure that an entire area of the sample has been irradiated. For example, as shown in FIG. 4D, the laser 112 can include an overlap ratio of approximately 0.5 such that subsequent locations along the sample overlap with the previous irradiated location to allow for gradual deformation of the sample surface. Moreover, overlap between subsequent irradiation positions along the sample allows for more granular control of the microstructure of the manufactured object following laser operation.

A person skilled in the art will recognize that the opaque overlay 110, whether it is made up of tape, paint (applied and fully dried on the substrate surface), powder, or liquid, is consumable. A person skilled in the art will recognize that while use of a powder or liquid may be preferred as these options are more easily removed as compared to tape and paint, which are more commonly used in conventional methods, the presently disclosed embodiments allow for use for tape and paint, as in the prior art, but with increased efficiency and greater ease of application and removal of the opaque overlay. Irradiation of a pulsed laser can ablate the opaque overlay 110 to create plasma, which can expand to create a shockwave on a surface of the opaque overlay, with the shockwave propagating through the material. That is, once the pulsed laser 112 is irradiated to the opaque layer, it consumes some amount of the layer to create a shock wave. Specifically, as noted above, the shock wave cold works the part and creates compressive residual stresses as it propagates into the material, which leads to an increase in surface hardness and fatigue life of the sample. The liquid opaque layer can be such that it is not dried when irradiated by the laser beam.

After the microstructure at the first position of the sample is sufficiently processed by the LSP operation, the platform 102 can move to a second position. In some embodiments, the platform 102 is compact to restrict coverage to a local area of the part where LSP is performed, thereby enabling performance of SLM in another portion of sample. As shown in FIG. 4C, the platform 102 can translate to the second position in which the first conduit 106a is in the second position while the second conduit 106b substantially aligns with the first location. A vacuum pump or another type of cleaning system, such as wiping, sweeping, or adhesive tapes, can extend into the second conduit 106b to be in communication with said conduit to collect residue, e.g., the liquid or powder overlay residue and byproducts of the LSP operation. A person skilled in the art will recognize that the cleaning system being in communication with the conduit can include fluid communication to permit the exchange and/or passing of substances in various states therebetween. For example, the cleaning system can collect any type of contaminants that occur during operation at any stage of the LSP process. In some embodiments, the cleaning system can collect one or more of liquid, gaseous, and/or solid contaminants, among others, including residue of the irradiation performed during the LSP process. Having the vacuum device introduced through the platform during the LSP operation removes extra steps after the LSP process to eliminate waste like sticky tape residue or dried paint, which is typically performed in the conventional LSP process and is often done manually. An amount of the transparent overlay and/or opaque overlay that is removed after the LSP process can depend, at least in part, on a strength of the laser being used, among other factors appreciated by a person skilled in the art. A person skilled in the art will recognize that the residue can include remnants of the irradiated opaque overlay, remnants of the irradiated transparent overlay, byproducts of the reaction between the laser and opaque overlay, byproducts of the reaction between the laser and transparent overlay, byproducts produced by reactions between the laser and the sample, and/or any possible contaminations generated by the LSP operation.

In some embodiments, multiple LSP processes can be performed without further supply of the opaque layer until the opaque layer applied beforehand is fully consumed. Also, additional supply of the opaque layer allows further LSP operations as many as needed to introduce sufficient deformation to the material. For example, the additional opaque layer can be supplied while the previously supplied opaque layer is being consumed by the LSP operations. Also, the opaque layer residue created from the previous LSP operation can be removed and a new opaque layer can be supplied in lieu of application of a new SLM layer. The ability of the presently disclosed system to easily supply and control an amount of the opaque layer that is delivered allows consecutive LSP processing actions to be readily performed as compared to conventional systems, in which tape or paint is used as the opaque overlay. For example, using a controllable liquid opaque layer enables multiple LSP processing actions without frequent removal and re-deposition of the opaque layer, which occurs in conventional systems. This helps allow the presently disclosed system to operate at a fraction of the cost and time of conventional systems in which tape or paint is used as the opaque overlay.

A person skilled in the art will recognize that the sequence of irradiating a portion of the sample or an opaque layer on the sample with the laser, moving the device to the next location, and activating the vacuum pump to collect residue can be repeated at desired locations along the perimeter, area, and/or volume of the sample. In some embodiments, the LSP operation and activation of the vacuum pump can occur substantially simultaneously such that the pulsed laser and the vacuum pump operate substantially at the same time. A person skilled in the art will recognize that substantially simultaneous operation includes the laser and the vacuum pump being activated within approximately 0.1 seconds of one another, though in some embodiments, substantially simultaneous operation can include from approximately 0.01 seconds to approximately 10 seconds. Once completed, a new powder layer can be added and selectively melted onto the deformed sample layer using SLM. After completion of SLM of the next layer, the LSP device can be reintroduced to deform the newly printed layers.

Adding the platform 102 to the SLM processes into a single device greatly reduces the amount of time taken to produce objects and enables property combinations of the manufactured part that cannot be reached by single-laser operation. Moreover, as mentioned above, the compact size of the device can enable substantially synchronous operations of SLM and LSP, which is a significant advantage over existing processes. For example, in the case of printing a metal part, using the presently disclosed techniques can reduce the production time, e.g., the time taken for printing and post-production, of said part by at least approximately 66%, with reduction in time of up to 75% also observed, by reducing or substantially eliminating post-processing heat treatments from the manufacturing process, as discussed below with respect to FIGS. 8A and 8B. Lastly, the presently disclosed system and methods enables control of the microstructure of a sample both locally and globally, which can enable customization of properties and can increase accuracy and detail of the manufactured part.

A person skilled in the art will recognize that because the platform 102 is inserted into a solidified and powder-free area of a sample in a printer build platform, the contamination or loss of costly powders is unlikely, with little to no contact between the powders and the opaque overlay being expected.

FIG. 5 illustrates another exemplary embodiment of an LSP device 100′ that is used to realize the in situ LSP operations during an SLM process. Except as indicated below or readily apparent to one skilled in the art, the various alternative embodiments described below can be similar or identical to the LSP device 100, with like-numbered and like-lettered components generally having similar features. Accordingly, description of the structure, operation, and use of such features is omitted herein for the sake of brevity. As shown, the device 100′ can include a surface or platform 102′ that extends between a proximal end 102p′ and a distal end 102d′. The platform 102′ can include a supplier 104′ attached thereto. The supplier 104′ can include a tube or another delivering means that extends through the platform 102′ to allow introduction of one or more substances into the platform. As shown, the device 100′ can include a first conduit 106a′ having an access path that extends from the proximal end 102p′ through the platform 102′ and terminates at the distal end 102d′ and a second conduit 106b′ that can serve as a vacuum pump connection. In some embodiments, a transparent layer 108′ can be coupled to the platform 102′ or otherwise disposed in the first conduit 106a′ to be overlaid onto the opaque layer delivered by the supplier 104′. The platform 102′ can be connected to a stage (not shown) as discussed in greater detail below.

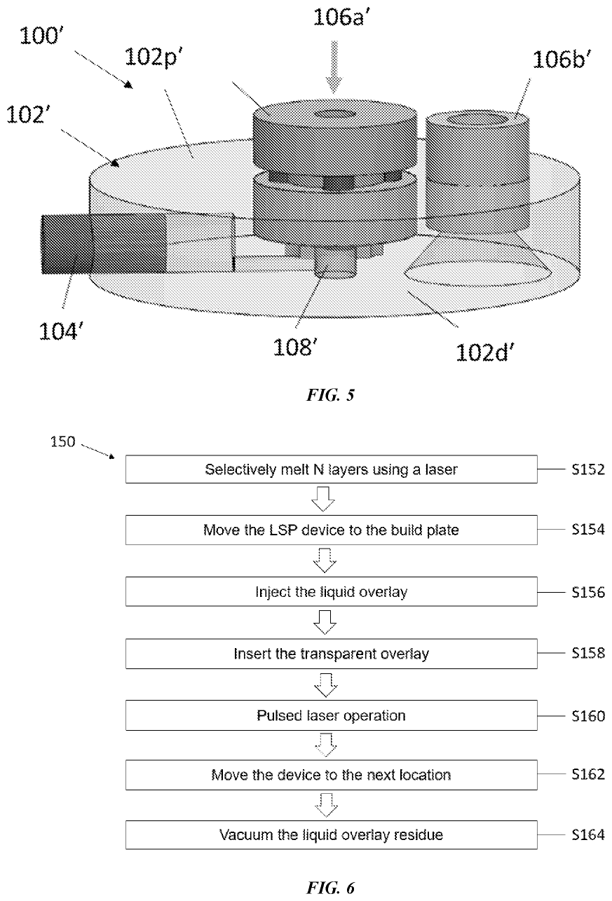

FIG. 6 illustrates an exemplary embodiment of an operation procedure 150 using the above-described devices. As shown, the operation procedure 150 includes an SLM process to selectively melt one or more layers of metallic powders using a laser (S152). As mentioned above, the SLM energy source can include a continuous laser, a pulsed laser, and/or an electron beam. Once the part is sufficiently built, the LSP device 100 can be moved to the printer build plate (S154). Once the LSP device 100 is positioned, the opaque overlay 110 can be added, e.g., injected, to the SLM-processed solidified layers of the metallic powder (S156), and the transparent overlay 108 can be added on top of the opaque overlay 110 (S158). The pulsed laser can be activated (S160) to generate a shock wave in a given location on the surface of the opaque overlay 110 to cold work the as-built part, which can increase a surface hardness and deform a surface of the opaque overlay to form the as-built layer. Once the opaque overlay sufficiently deforms at the given location, the LSP device 100 can be moved to a second location (S162) to repeat the above-described functions. Residue from the melting (S152) and the pulsed laser operation (S160) can be vacuumed using the cleaning system (S164), as described above, or other known cleaning techniques known to those skilled in the art and suitable for involvement in the process. Vacuuming of the residue can occur after pulsed laser operation has completed at a given location, though, in some embodiments, vacuuming can occur simultaneously, or near simultaneously (within less than a second, though it could be longer or substantially shorter than a second) with selective melting of the metallic powder and/or pulsed laser operation. As discussed above, the devices of the present embodiments can allow for local and global control of the microstructure of additively manufactured objects without the need of post-heat treatments.

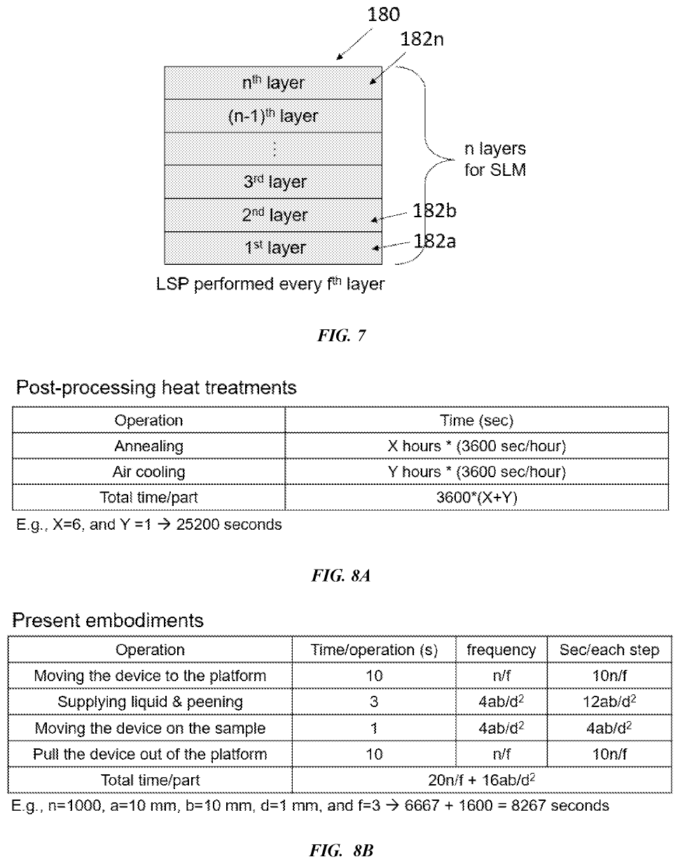

FIG. 7 illustrates an object 180 following an additive manufacturing SLM process having multiple layers. As shown, the object 180 can include a plurality of layers 182 stacked on top of one another such that each layer is adjacent to an earlier formed layer. As shown, a first layer 182a can be formed by SLM to melt the layer followed by LSP of the as-built, e.g., solidified, layer to deform the layer to a desired configuration. Once the layer is sufficiently deformed, a new layer, e.g. a second layer 182b, can be added onto the first layer 182a, for melting and pulsed laser irradiation using the LSP device 100. This sequence can be repeated for each subsequent layer, e.g., until the nth layer 182n, until the manufacturing of the object 180 is complete.

FIGS. 8A-8B comparatively illustrate the time saved to manufacture an object using the methods of the present disclosure, comparing post-processing heat treatments known in the art (FIG. 8A) with one non-limiting example of techniques of the present disclosure. As shown in FIG. 8A, conventional procedures for manufacture of objects that typically include post-processing heat treatments, can consume approximately 25,200 seconds, or approximately 7 hours. Manufacture of the same object using the processes of the present embodiments can be more than two to three times as fast, as shown in the embodiment of FIG. 8B, with manufacturing taking approximately 8,267 seconds, or approximately 2.29 hours. A person skilled in the art will recognize that the time taken for each of the manufacturing steps discussed in FIG. 8B is merely exemplary and can vary based on a number of factors, with some non-limiting examples of such factors being the diameter D of the laser 112, the number of layers 182 used to manufacture the object 180, or sample dimensions, among others.

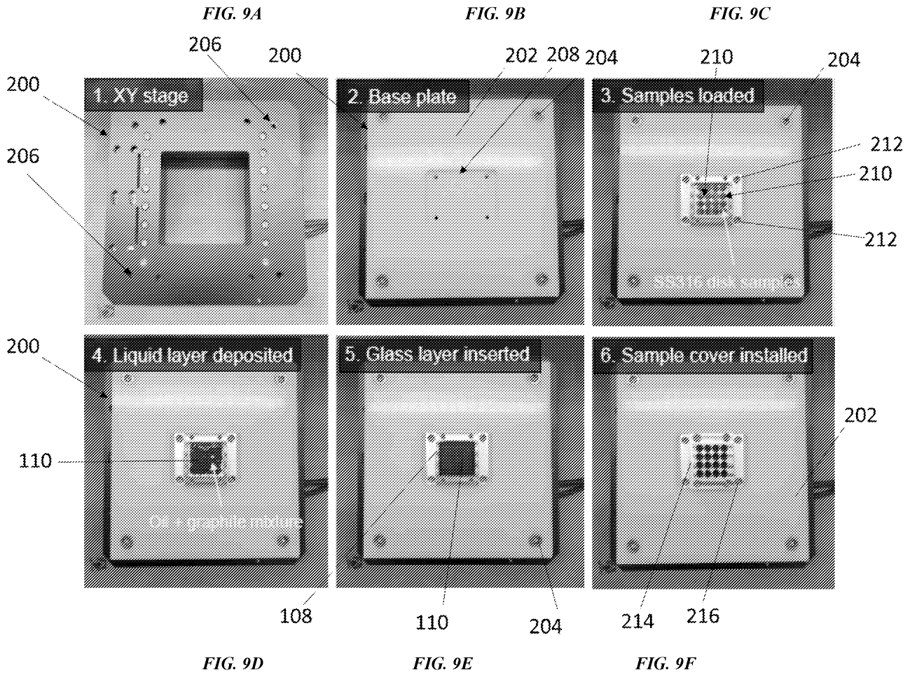

FIGS. 9A-9F illustrate an exemplary embodiment of a sequence of proof-of-principle experiments of the devices 100, 100′ discussed above. For example, FIG. 9A illustrates an exemplary embodiment of a stage 200. The stage 200 can include a base plate 202 placed thereon, as shown in FIG. 9B. The base plate 202 can be coupled to the stage 200 by one or more fasteners 204 received in openings in the base plate 202. The fasteners 204 can be received in corresponding openings 206 formed within the stage 200 to secure the base plate 202 to the stage 200.

The base plate 202 can include a recess 208 therein for receiving one or more samples 210 therein. As shown in FIG. 9C, the samples 210 can be disposed within the recess 208 and secured thereto by one or more fasteners 212. The samples 210 can include a metal sample, e.g., stainless steel SS316 disk samples. Once the samples are loaded, the liquid or powder layer 110 can be deposited onto the samples 210, as shown in FIG. 9D. As noted above, the liquid or powder layer 110 can include a base material such as water or oil, and energy-absorbing dispersants like graphite, carbon black, black ferric oxides, and/or mixtures thereof. The transparent layer 108 can then be inserted, as shown in FIG. 9E, with the transparent layer 108 serving as a substantially transparent or penetrable barrier through which a laser beam or energy source can travel without losing substantial amounts of energy. A sample cover 214 can then be installed over the samples 210, as shown in FIG. 9F, and secured with one or more additional fasteners 216 to the base plate 202.

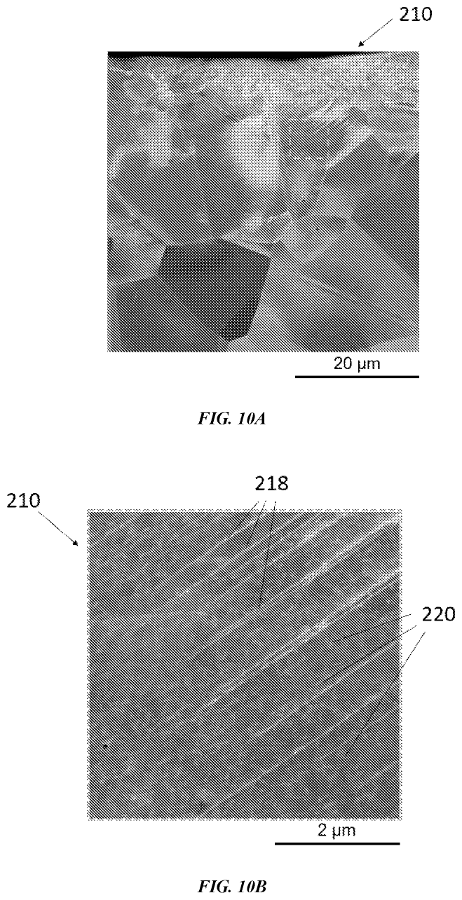

FIGS. 10A-10B illustrate the samples 210 following exposure to the laser beam. As shown in the cross-section micrograph of FIG. 10A, a surface of the sample 210 that is exposed to the laser beam exhibits patterns of defects in the material. These defects are shown in greater detail in FIG. 10B. As shown, the defects can include twins 218 and dislocations 220 formed in the cross-section of the samples 210. These defects illustrate the extent of local microstructure control over the surface of the sample using the methods discussed above. For example, the location, density, or types of the twins 218 and dislocations 220 can be controlled by multiple processing parameters of LSP, e.g., laser intensity, wavelength, frequency, pulse duration, pre-strain, surface finish, and so forth.

Examples of the above-described embodiments can include the following:
1. A printer, comprising:
   a vessel configured to supply one or more layers of a substance onto a build plate, the substance comprising at least one of one or more powders or one or more wires;
   a platform having one or more conduits formed therein;
   a first energy source configured to at least one of melt or fuse the one or more layers of substance to form a printed part;
   an applier configured to deposit one or more opaque materials on the one or more solidified layers of the printed part to form an opaque overlay, the one or more opaque materials comprising energy-absorbing particles suspended in a liquid;
   one or more transparent materials configured to be disposed above the deposited opaque materials to form a transparent overlay; and
   a laser in communication with at least one conduit of the one or more conduits, the laser being configured to irradiate at least a portion of at least one of the one or more deposited opaque materials that form the opaque overlay or the one or more transparent materials that form the transparent overlay,
   wherein at least one conduit of the one or more conduits is configured to be in communication with a cleaning system configured to remove at least a portion of residue from at least one of the one or more opaque materials or the one or more transparent materials, the removed portion not necessarily being the irradiated portion.
2. The printer of claim 1, wherein the first energy source further comprises at least one of a laser or an electron beam.
3. The printer of claim 1 or 2, further comprising a cleaning system in communication with at least one conduit of the one or more conduits, the cleaning system being configured to collect the residue of the irradiation.
4. The printer of claim 3, wherein the residue of the irradiation further comprises one or more of: i) a remnant of the one or more deposited opaque materials that form the opaque overlay after irradiation; ii) a byproduct produced by reactions between the laser and the deposited opaque materials or the deposited transparent materials; iii) a byproduct produced by reactions between the laser and the printed part; iv) a remnant of the one or more deposited transparent materials that form the transparent overlay after irradiation; or v) a contaminant of the irradiation.
5. The printer of claim 3 or 4, wherein the cleaning system further comprises one or more of a vacuum system, or a system configured to wipe, sweep, or use adhesive tapes to remove the residue.
6. The printer of any of claims 1 to 5, wherein a diameter of the platform can be approximately in the range of about 15 millimeters to about 150 millimeters
7. The printer of any of claims 1 to 6, wherein the platform is configured to translate relative to the one or more melted layers of the printed part such that the second energy source is configured to irradiate at least a portion of at least one of the one or more deposited opaque materials that form the opaque overlay or the one or more transparent materials that form the transparent overlay at a plurality of positions.
8. A method for manufacturing a part, comprising:
   positioning a sample onto a build plate of a printer;
   positioning a platform having one or more conduits in a first position over the sample;
   activating a laser to irradiate the sample;
   translating the platform to a second position relative to the sample;
   removing a residue that results from laser irradiation; and
   activating the laser to irradiate a further portion of the sample.
9. The method of claim 8, further comprising:
   depositing a first material onto the sample to form an opaque overlay;
   contacting the first material with a second material being made of a substantially transparent material to form a transparent overlay; and
   irradiating one or more of the first material or the second material with the laser.
10. The method of claim 9, wherein depositing a first material onto the sample to form an opaque overlay further comprises flowing or injecting the first material through a supplier to an opening of the one or more conduits.
11. The method of claim 9 or 10, wherein the first material comprises one or more of: a liquid mixture that includes oil or water; one or more inks; one or more solutions; one or more dispersions; one or more colloids; one or more suspensions; or one or more powder materials.
12. The method of any of claims 9 to 11, wherein removing a residue that results from laser irradiation further comprises removing a residue of at least one of the transparent overlay or the opaque overlay after irradiating one or more of the first material or the second material with the laser.
13. The method of any of claims 9 to 12, wherein the residue comprises one or more of: i) a remnant of the irradiated first material; ii) a byproduct produced by reactions between the laser and the first material or the second material; iii) a byproduct produced by reactions between the laser and the sample; iv) a remnant of the irradiated second material; or v) a contaminant of the irradiation.
14. The method of claim any of claims 8 to 13, wherein removing the residue further comprises one or more of applying a vacuum, wiping, sweeping, or using adhesive tapes to remove the residue.
15. The method of claim 14, wherein the vacuum is in communication with the one or more conduits of the platform to remove the residue.
16. The method of any of claims 8 to 15, wherein activating the laser and removing the residue occurs substantially simultaneously.
17. The method of any of claims 8 to 16, further comprising:
   repeating the following actions one or more additional times:
      activating the laser to irradiate the sample;
      translating the platform to at least one additional position relative to the sample; and
      removing a residue that results from laser irradiation.
18. A manufacturing system, comprising:
   a peening device having one or more conduits formed therein, the conduits extending substantially from a proximal end of the peening device to a distal end of the peening device to form an access path through the peening device; and
   a cleaning device in communication with one or more conduits of the one or more conduits of the peening device, the cleaning device being configured to clean residue that results from use of the peening device.
19. The system of claim 18, further comprising a supplier configured to deliver an opaque material to form an opaque layer on a surface of the peening device, the opaque material being one or more of a liquid mixture of oil/water, inks, solutions, dispersions, colloids, suspensions, or a powder material.
20. The system of claim 19, further comprising a transparent material configured to be disposed above the opaque material delivered by the supplier.
21. The system of claim 20, wherein the transparent material is configured to be disposed substantially uniformly over the opaque material.
22. The system of claim 20 or 21, wherein the transparent material is configured to receive a laser therethrough, the laser traveling substantially unimpeded through the transparent material to be absorbed by the opaque material.
23. The system of claim 22, wherein the laser and the cleaning device are configured to operate substantially simultaneously.
24. The system of any of claims 18 to 23, wherein the supplier is configured to deliver the opaque material substantially uniformly over one or more of the printed part or the surface of the peening device.
25. The system of any of claims 18 to 24, wherein the peening device is configured to translate relative to the supplier.
26. The system of any of claims 18 to 25, wherein a diameter of the platform is approximately in the range of about 15 millimeters to about 150 millimeters.
27. The system of any of claims 18 to 26, wherein the cleaning device extends at least one of distal to the distal end of the peening device or distal to a side end of the peening device.

One skilled in the art will appreciate further features and advantages of the disclosures based on the provided for descriptions and embodiments. Accordingly, the inventions are not to be limited by what has been particularly shown and described. All publications and references cited herein are expressly incorporated herein by reference in their entirety.

What is claimed is:

1. A printer, comprising:
a vessel configured to supply one or more layers of a substance onto a build plate, the substance comprising at least one of one or more powders or one or more wires;
a platform having one or more conduits formed therein;
a first energy source configured to at least one of melt or fuse the one or more layers of substance to form a printed part;
an applier configured to deposit one or more opaque materials on the one or more solidified layers of the printed part to form an opaque overlay, the one or more opaque materials comprising energy-absorbing particles suspended in a liquid;
one or more transparent materials configured to be disposed above the deposited opaque materials to form a transparent overlay; and
a laser in communication with at least one conduit of the one or more conduits, the laser being configured to irradiate at least a portion of at least one of the one or more deposited opaque materials that form the opaque overlay or the one or more transparent materials that form the transparent overlay,
wherein at least one conduit of the one or more conduits is configured to be in communication with a cleaning system configured to remove at least a portion of residue from at least one of the one or more opaque materials or the one or more transparent materials, the removed portion not necessarily being the irradiated portion.

2. The printer of claim 1, further comprising a cleaning system in communication with at least one conduit of the one or more conduits, the cleaning system being configured to collect the residue of the irradiation.

3. The printer of claim 2, wherein the residue of the irradiation further comprises one or more of: i) a remnant of the one or more deposited opaque materials that form the opaque overlay after irradiation; ii) a byproduct produced by reactions between the laser and the deposited opaque materials or the deposited transparent materials; iii) a byproduct produced by reactions between the laser and the printed part; iv) a remnant of the one or more deposited transparent materials that form the transparent overlay after irradiation; or v) a contaminant of the irradiation.

4. The printer of claim 2, wherein the cleaning system further comprises one or more of a vacuum system, or a system configured to wipe, sweep, or use adhesive tapes to remove the residue.

5. The printer of claim 1, wherein a diameter of the platform can be approximately in the range of about 15 millimeters to about 150 millimeters.

6. The printer of claim 1, wherein the platform is configured to translate relative to the one or more melted layers of the printed part such that the second energy source is configured to irradiate at least a portion of at least one of the one or more deposited opaque materials that form the opaque overlay or the one or more transparent materials that form the transparent overlay at a plurality of positions.

7. A method for manufacturing a part, comprising:
positioning a sample onto a build plate of a printer;
positioning a platform having one or more conduits in a first position over the sample;
activating a laser to irradiate the sample;
translating the platform to a second position relative to the sample;
removing a residue that results from laser irradiation; and
activating the laser to irradiate a further portion of the sample.

8. The method of claim 7, further comprising:
depositing a first material onto the sample to form an opaque overlay;
contacting the first material with a second material being made of a substantially transparent material to form a transparent overlay; and
irradiating one or more of the first material or the second material with the laser.

9. The method of claim 8, wherein depositing a first material onto the sample to form an opaque overlay further comprises flowing or injecting the first material through a supplier to an opening of the one or more conduits.

10. The method of claim 8, wherein the first material comprises one or more of: a liquid mixture that includes oil or water; one or more inks; one or more solutions; one or more dispersions; one or more colloids; one or more suspensions; or one or more powder materials.

11. The method of claim 8, wherein removing a residue that results from laser irradiation further comprises removing a residue of at least one of the transparent overlay or the opaque overlay after irradiating one or more of the first material or the second material with the laser.

12. The method of claim 8, wherein the residue comprises one or more of: i) a remnant of the irradiated first material; ii) a byproduct produced by reactions between the laser and the first material or the second material; iii) a byproduct produced by reactions between the laser and the sample; iv) a remnant of the irradiated second material; or v) a contaminant of the irradiation.

13. The method of claim 7, wherein a vacuum is in communication with the one or more conduits of the platform to remove the residue.

14. The method of claim 7, wherein activating the laser and removing the residue occurs substantially simultaneously.

15. A manufacturing system, comprising:
a peening device having one or more conduits formed therein, the conduits extending substantially from a proximal end of the peening device to a distal end of the peening device to form an access path through the peening device; and
a cleaning device in communication with one or more conduits of the one or more conduits of the peening device, the cleaning device being configured to clean residue that results from use of the peening device.

16. The system of claim 15, further comprising a supplier configured to deliver an opaque material to form an opaque layer on a surface of the peening device, the opaque material being one or more of a liquid mixture of oil/water, inks, solutions, dispersions, colloids, suspensions, or a powder material.

17. The system of claim 16, further comprising a transparent material configured to be disposed above the opaque material delivered by the supplier.

18. The system of claim 17, wherein the transparent material is configured to be disposed substantially uniformly over the opaque material.

19. The system of claim 15, wherein the laser and the cleaning device are configured to operate substantially simultaneously.

20. The system of claim 15, wherein the supplier is configured to deliver the opaque material substantially uniformly over one or more of the printed part or the surface of the peening device.
